(19) United States
(12) Patent Application Publication
(10) Pub. No.: US 2024/0328526 A1
(43) Pub. Date: Oct. 3, 2024

(54) Valve Box Liner Device

(71) Applicant: Eric Barnowski, Fair Haven, MI (US)

(72) Inventor: Eric Barnowski, Fair Haven, MI (US)

(21) Appl. No.: 18/519,280

(22) Filed: Nov. 27, 2023

Related U.S. Application Data
(60) Provisional application No. 63/493,021, filed on Mar. 30, 2023.

(51) Int. Cl. F16K 27/12

(52) U.S. Cl. CPC F16K 27/12

(57) ABSTRACT

A valve box liner device is disclosed, which is a multipurpose liner for a water, gas, or sewer main valve box. The valve box liner device comprises a body component that is configured as an inflatable tube with an inflation valve. The body component would be manufactured from a plastic material and prevent ice and debris from entering a valve box and rendering the valve inoperable. The body component measures 3-6 feet in length and 4 inches in diameter.

### CROSS-REFERENCE TO RELATED APPLICATION

The present application claims priority to, and the benefit of, U.S. Provisional Application No. 63/493,021, which was filed on Mar. 30, 2023, and is incorporated herein by reference in its entirety.

### FIELD OF THE INVENTION

The present invention relates generally to the field of valve box liner devices. More specifically, the present invention relates to an inflatable cylinder with a low-pressure inflation valve on the top, allowing air to enter the device and prevent any debris, water, or ice from filling the void in a valve box. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, this invention relates to improvements in valve box liner devices. Generally, utility valve boxes can get filled with debris like silt, sand, water, etc. Further, moisture within the boxes can freeze, forming ice which will block access to the valve. Additionally, any type of solid debris can build up within the system and prevent operation of the valve. Accordingly, time money and manpower spent accessing plugged valve boxes can become overwhelming.

Further, most utility valve boxes are exposed to the elements, and their lids can be removed, or left open, or general leaks can exist which allow water and/or dirt and debris to enter the utility valve boxes. This water, dirt, and/or debris can fill up over time and clog a utility valve box, causing a user to spend time removing the water, dirt, and debris when access to the utility valve box is needed. Removing dirt, debris, and water from a utility valve box is never easy and can take considerable time to perform. Thus, it would be desirable to have an easier means for cleaning out utility valve boxes.

Accordingly, there is a demand for an improved valve box liner device that prevents utility valve boxes from becoming clogged by dirt, debris, and water. More particularly, there is a demand for an improved valve box liner device that acts as a liner to prevent obstructions from entering the valve box and rendering the valve inoperable.

Therefore, there exists a long-felt need in the art for a valve box liner device that provides users with an inflatable cylinder with a low-pressure inflation valve on the top, allowing air to enter the device and prevent any debris, water, or ice from filling the void in a valve box. There is also a long-felt need in the art for a valve box liner device that allows users to place the cylinder in the valve box and inflate it with a simple, low-PSI billow pump to fill space. Further, there is a long-felt need in the art for a valve box liner device that enables users to deflate the tube and remove it for accessing the valve box for maintenance and/or repairs. Moreover, there is a long-felt need in the art for a device that improves efficiency for water, gas, or sewer main valve boxes to prevent them from becoming inoperable at any time. Further, there is a long-felt need in the art for a valve box liner device that multipurpose liner for a water, gas, or sewer main valve box. Finally, there is a long-felt need in the art for a valve box liner device that can be inserted and removed, as needed.

The subject matter disclosed and claimed herein, in one embodiment thereof, comprises a valve box liner device. The device is a multipurpose liner for a water, gas, or sewer main valve box. The valve box liner device comprises a body component that is configured as an inflatable tube with an inflation valve. The body component would be manufactured from a plastic material and prevent ice and debris from entering a valve box and rendering the valve inoperable. The body component measures 3-6 feet in length and 4 inches in diameter.

In use, the device is inserted into the valve box from the top of the valve nut to just below the valve box lid. The body component is then inflated by using a simple low-pressure hand air pump via the inflation valve. Once inflated, the device prevents obstructions from entering the valve box. To remove the device, users can release the pressure and deflate the body component via the inflation valve and then remove the device from the valve box.

In this manner, the valve box liner device of the present invention accomplishes all of the foregoing objectives and provides users with a device that improves efficiency for water, gas, or sewer main valve boxes to prevent them from becoming inoperable at any time. The device is an inflatable tube with an inflation valve. The device can be manufactured of a plastic material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a valve box liner device. The device is a multipurpose liner for a water, gas, or sewer main valve box. The valve box liner device comprises a body component that is configured as an inflatable tube with an inflation valve. The body component would be manufactured from a plastic material and prevent ice and debris from entering a valve box and rendering the valve inoperable.

In one embodiment, the valve box liner device comprises a body component configured as an inflatable tube. Specifically, the body component is in the shape of a cylinder having two ends (i.e., a first and a second end) and a shaft between the two ends. Each of the ends are hermetically sealed, so as to be airtight and waterproof. Typically, the ends can be sealed via heat sealing, ultrasonic sealing, and adhesives, etc., or any other suitable sealing means as is known in the art. Further, the body component comprises a front surface, a back surface, opposing sides, and opposing top and bottom ends. Additionally, the first end is positioned at the top end and the second end is positioned at the bottom end. The body component can be formed via two separate, identical plastic sheets secured together at their ends to form the cylindrical configuration (i.e., inflatable tube). In another embodiment, the body component is formed from one single, integral sheet that can be configured as the inflatable tube (i.e., cylindrical configuration).

In one embodiment, the body component can be any suitable shape and size as is known in the art. Typically, the body component is manufactured in different lengths, measuring approximately three to six feet in length, depending on the size of the valve box being utilized. Generally, the body component is approximately four inches in diameter but can be any suitable size as is known in the art, depending on the size of the valve box being utilized. The sealed ends of the body component form an internal cavity within the shaft, which can hold air to create a bladder or pillow-like shape when filled.

In one embodiment, the first end of the body component comprises an air inflation valve that extends through the front surface and is in fluid communication with the internal cavity of the body component. The air inflation valve can be any suitable air inflation valve that allows air to be pumped into the internal cavity, to fill the internal cavity with air and create a bladder or pillow. The air inflation valve can be an air valve similar to those found in inflatable toys, pool floats, etc., or any other suitable air valve that utilizes low-pressure (i.e., 2-4 psi) to inflate the object.

In one embodiment, the air inflation valve comprises an air entrance spout component where air is pumped into the internal cavity and a cap component which seals the spout component to prevent air from leaking out. The cap component is typically attached via a strap to the spout component to prevent it from being misplaced or lost. The cap component allows the body component to be resealable. Thus, a user removes the cap component and utilizes a simple, low-PSI billow pump or other suitable low-pressure hand air pump to pump air into the internal cavity. Once the internal cavity is filled, the pump is removed from the spout component, and the cap component is replaced, scaling the body component. When the device needs to be removed, the cap component is removed and the body component is deflated, allowing the device to be removed, as needed.

In one embodiment, the body component is inflated by applying a low-pressurized air source or pump to the air inflation valve. Pressurized air travels through the air inflation valve into the internal cavity. As the pressure increases, the body component begins to expand into a bladder-like configuration. The body component will not break down, since it is not allowed to expand more than the confines of the valve box, and thus should not surpass the elastic limit of the elastomer of which it is constructed. Accordingly, the body component is inflated to an extent necessary to fill the interior of the valve box and prevent obstructions from entering the valve box.

In one embodiment, when inflated, the body component may have a generally cylindrical shape and has a generally circular cross-section, although other suitable shapes, such as rectangular or ellipse may also be used. Additionally, when the body component is uninflated, opposite surfaces (i.e., the front and back surfaces) of the body component may generally lie flat one on top of the other, with each flat surface corresponding to approximately half the circumference of the inflated body component.

In one embodiment, the first end of the body component also comprises a rope or strap that is secured to the opposing sides of the first end. The rope or strap can be secured via any suitable securing means, such as gluing, adhesive, staples, heat sealing, etc. The rope or strap is secured such that each end of the rope is secured to each opposing end of the first end, allowing the rope to create a loop or circular strap that allows a user to grasp to hold the device. Any suitable length of rope can be used, as long as the rope allows a user to easily grasp the rope to hold the device in position until the body component is filled with air.

In one embodiment, the body component can further be fitted with a flexible, outer covering which protects the body component from abrasion, punctures, leaks, damages, and/or weather, but still allows the body component to be inflated for use. The outer covering may fit over the body component but may not be attached to the body component. Alternatively, the outer covering may be attached to the body component at selected points or regions.

In one embodiment, the valve box liner device is manufactured of a lightweight, durable material such as a plastic material or vacuum sealed plastic material, or the like and manufactured through common blow molding and vacuum molding processes. Specifically, the device can be manufactured from heat-scalable plastic or polymers, such as polypropylene or acrylonitrile-butadiene-styrene (ABS), or any other suitable material as is known in the art, such as, but not limited to, polyethylene, polyethylene terephthalate, polyvinyl chloride, polystyrene, etc. Generally, the valve box liner device is also manufactured from a material that is water resistant or waterproof, or the body component comprises a coating that is water resistant or waterproof.

In use, the valve box liner device is inserted into the valve box from the top of the valve nut to just below the valve box lid. A user would grasp the rope at the top of the device and hold the device in position within the valve box. The body component of the device is then inflated by using a simple low-pressure hand air pump via the air inflation valve at the first end. Once inflated, the device remains in position within the valve box and prevents obstructions from entering the valve box. To remove the device, users can release the pressure and deflate the body component via the air inflation valve and then remove the device from the valve box. The valve box liner device is available in various sizes and lengths to fit into any size valve box, as needed.

In yet another embodiment, the valve box liner device comprises a plurality of indicia.

In yet another embodiment, a method of preventing dirt and debris from entering a valve box is disclosed. The method includes the steps of providing a valve box liner device comprising a body component that is configured as an inflatable tube with an inflation valve. The method also comprises inserting the body component into the valve box from the top of the valve nut to just below the valve box lid. Further, the method comprises retaining the body component in position via the rope at the top of the body component. The method also comprises inflating the body component by using a simple low-pressure hand air pump via the inflation valve. Finally, the method comprises preventing obstructions from entering the valve box via the inflated body component of the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the valve box liner device of the present invention showing the different sizes of the device in accordance with the disclosed architecture;

FIG. 2 illustrates a perspective view of one embodiment of the valve box liner device of the present invention showing how the device has a rope at the top for holding the device until it is filled with air in accordance with the disclosed architecture;

FIGS. 3A-B illustrate a perspective view of one embodiment of the valve box liner device of the present invention showing how the device uses low-pressure to prevent valve boxes from filling with debris in accordance with the disclosed architecture;

FIG. 4 illustrates a perspective view of one embodiment of the valve box liner device of the present invention in use in accordance with the disclosed architecture; and

FIG. 5 illustrates a flowchart showing the method of preventing dirt and debris from entering a valve box in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a valve box liner device that provides users with an inflatable cylinder with a low-pressure inflation valve on the top, allowing air to enter the device and prevent any debris, water, or ice from filling the void in a valve box. There is also a long-felt need in the art for a valve box liner device that allows users to place the cylinder in the valve box and inflate it with a simple, low-PSI billow pump to fill space. Further, there is a long-felt need in the art for a valve box liner device that enables users to deflate the tube and remove it for accessing the valve box for maintenance and/or repairs. Moreover, there is a long-felt need in the art for a device that improves efficiency for water, gas, or sewer main valve boxes to prevent them from becoming inoperable at any time. Further, there is a long-felt need in the art for a valve box liner device that multipurpose liner for a water, gas, or sewer main valve box. Finally, there is a long-felt need in the art for a valve box liner device that can be inserted and removed, as needed.

The present invention, in one exemplary embodiment, is a novel valve box liner device. The device is a multipurpose liner for a water, gas, or sewer main valve box. The valve box liner device comprises a body component that is configured as an inflatable tube with an inflation valve. The body component would be manufactured from a plastic material and prevent ice and debris from entering a valve box and rendering the valve inoperable. The body component measures 3-6 feet in length and 4 inches in diameter. The present invention also includes a novel method of preventing dirt and debris from entering a valve box. The method includes the steps of providing a valve box liner device comprising a body component that is configured as an inflatable tube with an inflation valve. The method also comprises inserting the body component into the valve box from the top of the valve nut to just below the valve box lid. Further, the method comprises retaining the body component in position via the rope at the top of the body component. The method also comprises inflating the body component by using a simple low-pressure hand air pump via the inflation valve. Finally, the method comprises preventing obstructions from entering the valve box via the inflated body component of the device.

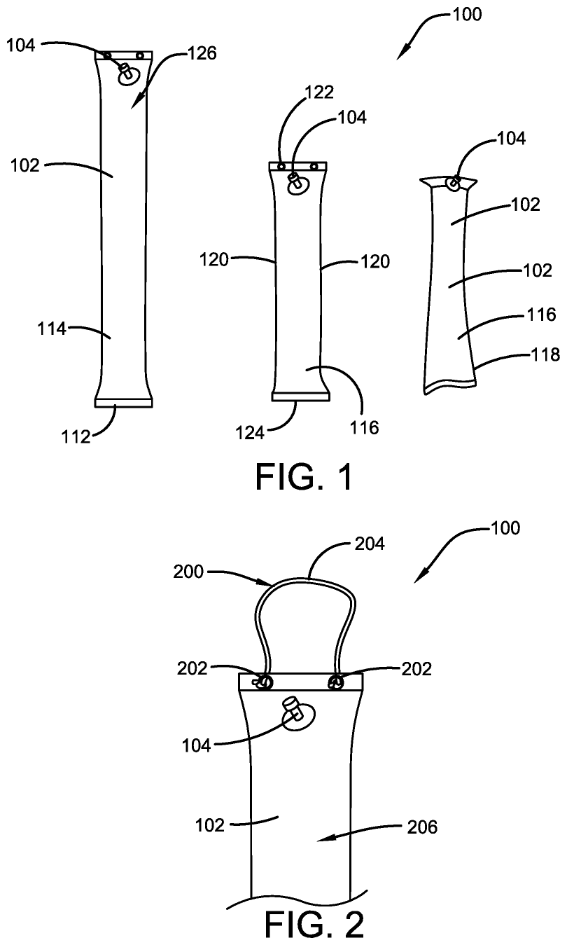

Referring initially to the drawings, FIG. 1 illustrates a perspective view of one embodiment of the valve box liner device 100 of the present invention. In the present embodiment, the valve box liner device 100 is an improved valve box liner device 100 that provides a user with a multipurpose liner for a water, gas, or sewer main valve box 106. Specifically, the valve box liner device 100 comprises a body component 102 with an air inflation valve 104. The body component 102 is generally configured as an inflatable tube, which can be inflated via the air inflation valve 104. Once inflated, the body component 102 prevents ice and debris from entering a valve box 106 and rendering the valve 108 inoperable.

Generally, the valve box liner device 100 comprises a body component 102 configured as an inflatable tube. Specifically, the body component 102 is in the shape of a cylinder having two ends (i.e., a first 110 and a second 112 end) and a shaft 114 between the two ends 110 and 112. Each of the ends 110 and 112 are hermetically sealed, to be airtight and waterproof. Typically, the ends 110 and 112 can be sealed via heat sealing, ultrasonic sealing, and adhesives, etc., or any other suitable sealing means as is known in the art. Further, the body component 102 comprises a front surface 116, a back surface 118, opposing sides 120, and opposing top 122 and bottom 124 ends. Additionally, the first end 110 is positioned at the top end 122 and the second end 112 is positioned at the bottom end 124. The body component 102 can be formed via two separate, identical plastic sheets secured together at their ends to form the cylindrical configuration (i.e., inflatable tube). In another embodiment, the body component 102 is formed from one single, integral sheet that can be configured as the inflatable tube (i.e., cylindrical configuration).

Furthermore, the body component 102 can be any suitable shape and size as is known in the art. Typically, the body component 102 is manufactured in different lengths, measuring approximately three to six feet in length, depending on the size of the valve box 106 being utilized. Generally, the body component 102 is approximately four inches in diameter but can be any suitable size as is known in the art, depending on the size of the valve box 106 being utilized. The scaled ends 110 and 112 of the body component 102 form an internal cavity 126 within the shaft 114, which can hold air to create a bladder or pillow-like shape when filled.

As shown in FIG. 2, the first end 110 of the body component 102 also comprises a rope 200 or strap that is secured to the opposing sides 120 of the first end 110. The rope 200 or strap can be secured via any suitable securing means, such as gluing, adhesive, staples, heat sealing, etc. The rope 200 or strap is secured such that each end 202 of the rope 200 is secured to each opposing end 120 of the first end 110, allowing the rope 200 to create a loop 204 or circular strap that allows a user to grasp to hold the device 100. Any suitable length of rope 200 can be used, as long as the rope 200 allows a user to easily grasp the rope 200 to hold the device 100 in position until the body component 102 is filled with air.

In one embodiment, the body component 102 can further be fitted with a flexible, outer covering 206 which protects the body component 102 from abrasion, punctures, leaks, damages, and/or weather, but still allows the body component 102 to be inflated for use. The outer covering 206 may fit over the body component 102 but may not be attached to the body component 102. Alternatively, the outer covering 206 may be attached to the body component 102 at selected points or regions.

Further, the valve box liner device 100 is manufactured of a lightweight, durable material such as a plastic material or vacuum sealed plastic material, or the like and manufactured through common blow molding and vacuum molding processes. Specifically, the device 100 can be manufactured from heat-scalable plastic or polymers, such as polypropylene or acrylonitrile-butadiene-styrene (ABS), or any other suitable material as is known in the art, such as, but not limited to, polyethylene, polyethylene terephthalate, polyvinyl chloride, polystyrene, etc. Generally, the valve box liner device 100 is also manufactured from a material that is water resistant or waterproof, or the body component 102 comprises a coating that is water resistant or waterproof.

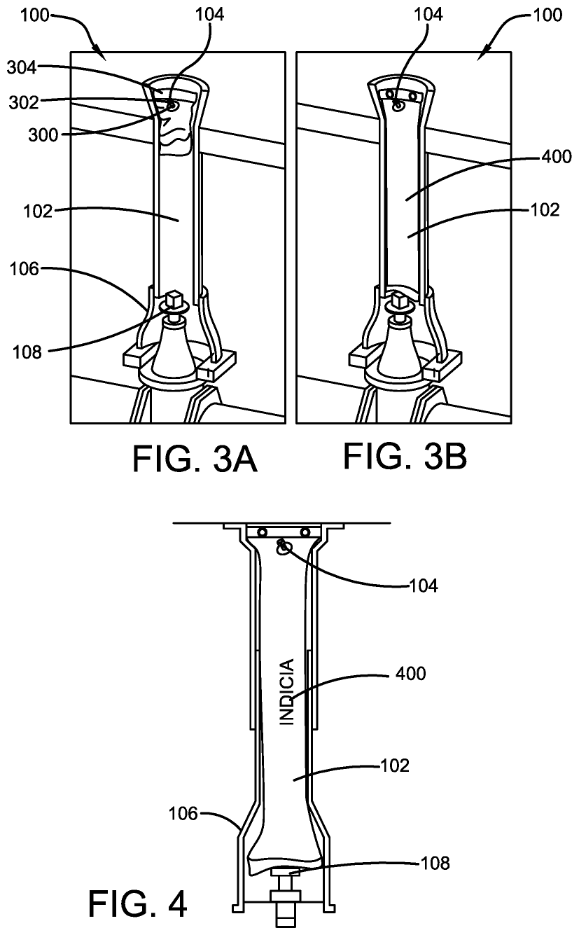

As shown in FIGS. 3A-B, the first end 110 of the body component 102 comprises an air inflation valve 104 that extends through the front surface 116 and is in fluid communication with the internal cavity 126 of the body component 102. The air inflation valve 104 can be any suitable air inflation valve 104 that allows air to be pumped into the internal cavity 126, to fill the internal cavity 126 with air and create a bladder or pillow. The air inflation valve 104 can be an air valve similar to those found in inflatable toys, pool floats, etc., or any other suitable air valve that utilizes low-pressure (i.e., 2-4 psi) to inflate the object.

Furthermore, the air inflation valve 104 comprises an air entrance spout component 300 where air is pumped into the internal cavity 126 and a cap component 302 which seals the spout component 300 to prevent air from leaking out through. The cap component 302 is typically attached via a strap 304 to the spout component 300 to prevent it from being misplaced or lost. The cap component 302 allows the body component 102 to be resealable. Thus, a user removes the cap component 302 and utilizes a simple, low-PSI billow pump or other suitable low-pressure hand air pump to pump air into the internal cavity 126. Once the internal cavity 126 is filled, the pump is removed from the spout component 300 and the cap component 302 is replaced, sealing the body component 102. When the device 100 needs to be removed, the cap component 302 is removed and the body component 102 is deflated, allowing the device 100 to be removed, as needed.

Generally, the body component 102 is inflated by applying a low-pressurized air source or pump to the air inflation valve 104. Pressurized air travels through the air inflation valve 104 into the internal cavity 126. As the pressure increases, the body component 102 begins to expand into a bladder-like configuration. The body component 102 will not break down, since it is not allowed to expand more than the confines of the valve box 106, and thus should not surpass the elastic limit of the elastomer of which it is constructed. Accordingly, the body component 102 is inflated to an extent necessary to fill the interior of the valve box 106 and prevent obstructions from entering the valve box 106.

Further, when inflated, the body component 102 may have a generally cylindrical shape and has a generally circular cross-section, although other suitable shapes, such as rectangular or ellipse may also be used. Additionally, when the body component 102 is uninflated, opposite surfaces (i.e., the front 116 and back 118 surfaces) of the body component 102 may generally lie flat one on top of the other, with each flat surface corresponding to approximately half the circumference of the inflated body component 102.

As shown in FIG. 4, in use, the valve box liner device 100 is inserted into the valve box 106 from the top of the valve nut to just below the valve box lid. A user would grasp the rope 200 at the top 122 of the device 100 and hold the device 100 in position within the valve box 106. The body component 102 of the device 100 is then inflated by using a simple low-pressure hand air pump (not shown) via the air inflation valve 104 at the first end 110. Once inflated, the device 100 remains in position within the valve box 106 and prevents obstructions from entering the valve box 106. To remove the device 100, users can release the pressure and deflate the body component 102 via the air inflation valve 104 and then remove the device 100 from the valve box 106. The valve box liner device 100 is available in various sizes and lengths to fit into any size valve box 106, as needed.

In yet another embodiment, the valve box liner device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be valve box, liner, or brand related.

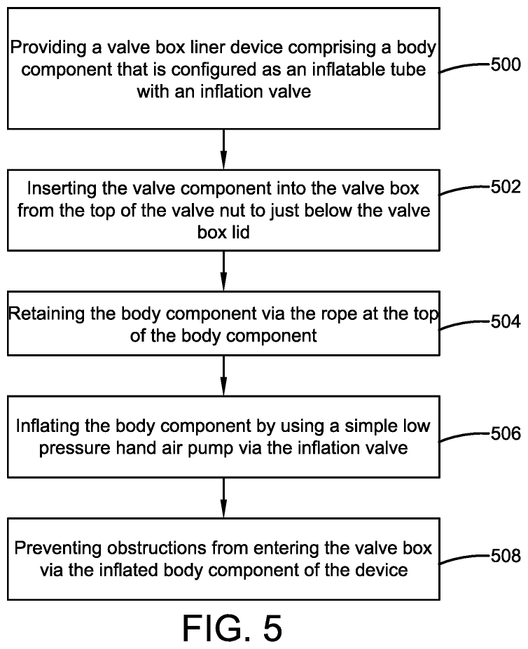

FIG. 5 illustrates a flowchart of the method of preventing dirt and debris from entering a valve box. The method includes the steps of at 500, providing a valve box liner device comprising a body component that is configured as an inflatable tube with an inflation valve. The method also comprises at 502, inserting the body component into the valve box from the top of the valve nut to just below the valve box lid. Further, the method comprises at 504, retaining the body component in position via the rope at the top of the body component. The method also comprises at 506, inflating the body component by using a simple low-pressure hand air pump via the inflation valve. Finally, the method comprises at 508, preventing obstructions from entering the valve box via the inflated body component of the device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “valve box liner device”, “valve box device”, “liner device”, and “device” are interchangeable and refer to the valve box liner device 100 of the present invention.

Notwithstanding the foregoing, the valve box liner device 100 of the present invention can be of any suitable size and configuration as is known in the art without affecting the overall concept of the invention, provided that it accomplishes the above-stated objectives. One of ordinary skill in the art will appreciate that the valve box liner device 100 as shown in FIGS. 1-5 is for illustrative purposes only, and that many other sizes and shapes of the valve box liner device 100 are well within the scope of the present disclosure. Although the dimensions of the valve box liner device 100 are important design parameters for user convenience, the valve box liner device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A valve box liner device that provides a user with a multipurpose liner for a water, gas or sewer main valve box, the valve box liner device comprising:
a body component; and
an air inflation valve;
wherein the body component is configured as an inflatable tube;
wherein the body component comprises an internal cavity that is inflated with air via the air inflation valve; and
further wherein once inflated, the body component prevents ice and debris from entering a valve box and rendering a valve inoperable.

2. The valve box liner device of claim 1, wherein the body component is in shape of a cylinder having a first end and a second end, and a shaft between the first end and the second end.

3. The valve box liner device of claim 2, wherein the first end and the second end are hermetically sealed, so as to be airtight and waterproof, and to form an internal cavity within the shaft which holds air.

4. The valve box liner device of claim 3, wherein the body component comprises a front surface, a back surface, opposing sides, and opposing top and bottom ends.

5. The valve box liner device of claim 4, wherein the first end is positioned at the top end and the second end is positioned at the bottom end.

6. The valve box liner device of claim 5, wherein the body component is manufactured in different lengths, measuring approximately three to six feet in length and four inches in diameter.

7. The valve box liner device of claim 6, wherein the first end of the body component comprises a rope that is secured to the opposing sides of the first end to create a loop that allows a user to grasp to hold the valve box liner device in position within the valve box before inflation.

8. The valve box liner device of claim 7, wherein the air inflation valve extends through the front surface and is in fluid communication with the internal cavity of the body component.

9. The valve box liner device of claim 8, wherein the air inflation valve comprises a spout component where air is pumped into the internal cavity and a cap component which seals the spout component to prevent air from leaking out through.

10. The valve box liner device of claim 9, wherein the cap component is attached via a strap to the spout component to prevent it from being misplaced or lost.

11. The valve box liner device of claim 10, wherein when the body component is uninflated, the front and back surfaces of the body component may generally lie flat one on top of the other, with each flat surface corresponding to approximately half circumference of the body component.

12. A valve box liner device that provides a user with a multipurpose liner for a water, gas or sewer main valve box, the valve box liner device comprising:
a body component in shape of a cylinder having a first end and a second end and a shaft between the first end and the second end; and
an air inflation valve which extends through a front surface and is in fluid communication with an internal cavity of the body component;
wherein the body component is configured as an inflatable tube;
wherein the body component comprises a front surface, a back surface, opposing sides, and opposing top and bottom ends;
wherein the first end is positioned at the top end and the second end is positioned at the bottom end;
wherein the first end and the second end are hermetically sealed, so as to be airtight and waterproof, and to form an internal cavity within the shaft which holds air;
wherein the internal cavity is inflated with air via the air inflation valve;
wherein the first end of the body component comprises a rope that is secured to the opposing sides of the first end to create a loop that allows a user to grasp to hold the valve box liner device in position within the valve box before inflation; and
further wherein once inflated, the body component prevents ice and debris from entering a valve box and rendering a valve inoperable.

13. The valve box liner device of claim 12 further comprising a plurality of indicia.

14. The valve box liner device of claim 12, wherein the body component can further be fitted with a flexible, outer covering which protects the body component from abrasion, punctures, leaks, damages, or weather, but still allows the body component to be inflated for use.

15. The valve box liner device of claim 12, wherein the body component is manufactured in different lengths, measuring approximately three to six feet in length and four inches in diameter.

16. The valve box liner device of claim 12, wherein the air inflation valve comprises a spout component where air is pumped into the internal cavity.

17. The valve box liner device of claim 16, wherein the air inflation valve comprises a cap component which seals the spout component to prevent air from leaking out through.

18. The valve box liner device of claim 17, wherein the cap component is attached via a strap to the spout component to prevent it from being misplaced or lost.

19. The valve box liner device of claim 12, wherein when the body component is uninflated, the front and back surfaces of the body component may generally lie flat one on top of the other, with each flat surface corresponding to approximately half circumference of the body component.

20. A method of preventing dirt and debris from entering a valve box, the method comprising the following steps:
providing a valve box liner device comprising a body component that is configured as an inflatable tube with an inflation valve;
inserting the body component into the valve box from the top of the valve nut to just below the valve box lid;
retaining the body component in position via the rope at the top of the body component; inflating the body component by using a simple low-pressure hand air pump via the inflation valve; and
preventing obstructions from entering the valve box via the inflated body component of the device.
